(19) United States
(12) Patent Application Publication
(10) Pub. No.: US 2026/0032547 A1
(43) Pub. Date: Jan. 29, 2026

(54) SYSTEM FOR PATH-AWARE MOBILITY MANAGEMENT AND MOBILITY-MANAGEMENT-AWARE PATH PLANNING FOR ROBOTS

(71) Applicant: INTEL CORPORATION, Santa Clara, CA (US)

(72) Inventors: Susruth SUDHAKARAN, Beaverton, OR (US); Dave CAVALCANTI, Portland, OR (US); Mark EISEN, Beaverton, OR (US); Javier PEREZ-RAMIREZ, North Plains, OR (US); Juan FANG, Portland, OR (US)

(21) Appl. No.: 18/992,988

(22) PCT Filed: Aug. 17, 2022
(86) PCT No.: PCT/CN2022/113140

§ 371 Date: Jan. 10, 2025

(51) Int. Cl. H04W 36/32; G05D 1/229

(52) U.S. Cl. CPC H04W 36/322; G05D 1/229

(57) ABSTRACT

Disclosed herein are systems, methods, and devices for providing mobility management and path planning with an interface between the mobility management functions and path planning functions. A mobility controller may receive an expected location into which a robot plans to move at a predefined time and determine, based on the expected location and a current location of the robot, an infrastructure configuration for a wireless infrastructure device that provide wireless connectivity at the expected location. The mobility controller may also generate a message to configure the wireless infrastructure device at the predefined time according to the infrastructure configuration.

### TECHNICAL FIELD

The disclosure relates generally to mobility management among wireless infrastructure devices and to robot movement planning, and in particular, to systems, devices, and methods of providing mobility management and path planning for robots that may utilize wireless communications when moving about a work environment.

### BACKGROUND

Autonomous robots are becoming increasingly widespread in work and personal environments. Due to their size and cost, many such robots may offload processing or memory storage to the edge or cloud and therefore often require highly reliable wireless connectivity to the edge/cloud when performing tasks. If the robot is also moving about a work environment, the availability, reliability, and quality of the wireless connectivity may change as the robot moves about the environment and roams from one access point to another access point. If the robot roams onto a new access point, where the new access point has poor availability, reliability, or quality of the wireless connection, the robot may need to stop, pause, or cancel further work/movements until the wireless connection is sufficiently restored. In addition, the handover from one access point to the next may involve a handover latency that may delay the robot's wireless communications, thereby causing processing delays that may impact the ability of the robot to operate continuously and/or safely during the handover.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary aspects of the disclosure are described with reference to the following drawings, in which:

FIG. 1 shows an exemplary system that provides an interface between a path planner for the robot and a mobility controller for wireless infrastructure equipment;

FIGS. 2A and 2B show an exemplary environment in which a robot may operate that has been divided into locations, where each location is associated with wireless connectivity information for the location;

FIG. 3 illustrates an exemplary schematic drawing of a device that may include a roaming interface between a path planner for the robot and a mobility controller; and

FIGS. 4-5 depict exemplary schematic flow diagrams of a method for interfacing between a path planner for the robot and a mobility controller for wireless infrastructure equipment.

### DESCRIPTION

The following detailed description refers to the accompanying drawings that show, by way of illustration, exemplary details and features.

The word “exemplary” is used herein to mean “serving as an example, instance, or illustration”. Any aspect or design described herein as “exemplary” is not necessarily to be construed as preferred or advantageous over other aspects or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc., where “[ . . . ]” means that such a series may continue to any higher number). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements],” “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc., where “[ . . . ]” means that such a series may continue to any higher number).

The phrases “group (of),” “set (of),” “collection (of),” “series (of),” “sequence (of),” “grouping (of),” etc., in the description and in the claims, if any, refer to a quantity equal to or greater than one, i.e., one or more. The terms “proper subset,” “reduced subset,” and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data,” however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as radio frequency (RF) transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both “direct” calculations via a mathematical expression/formula/relationship and “indirect” calculations via lookup or hash tables and other array indexing or searching operations.

A “robot” may be understood to include any type of digitally controllable machine that is designed to perform a task or tasks. By way of example, a robot may be a mobile unit or an autonomous mobile robot (AMR) that may move within an environment (e.g., a manufacturing floor, an office building, a warehouse, etc.) to perform a task or tasks; or a robot may be understood as an automated machine with arms, tools, and/or sensors that may perform a task or tasks at a fixed location; or any combination thereof.

Today's robots may offload certain data storage or data processing functions (e.g., for sensing, safety monitoring, motion planning, obstacle detection, information gathering, etc.) to the edge or cloud, and, as a result, the robot may require a highly reliable wireless connection while moving/performing tasks. Especially if the robot is moving within a work environment, the availability, reliability, and quality of the wireless connectivity may change as the robot moves from location to location within the environment or when changes are made to the properties of the current wireless connection. If there are multiple access points in the work environment, if the current wireless connection properties change or as the robot moves, the robot may decide to switch to a different access point (e.g., roam from using one access point for wireless connectivity to using another access point for wireless connectivity). If the robot roams onto a new access point that has poor availability, reliability, or quality of the wireless connection, the robot may need to stop, pause, or cancel further work/movements until sufficient wireless connectivity is restored. In addition, the handover from one access point to the next may involve a handover latency which may delay the robot's wireless communications, thereby causing processing delays that may impact the ability of the robot to operate continuously and/or safely during the handover.

As should be apparent from the detailed disclosure below, the mobility management and path planning systems disclosed below may reduce the likelihood that a robot moves into an area with insufficient wireless connectivity, roams onto a new access point with insufficient wireless connectivity, or encounters an unacceptably long handover latency when roaming. For example, the systems disclosed below may include an interface between the mobility management functions of the wireless infrastructure devices (e.g., wireless access points) and the path planning functions of the robots moving within the environment, allowing each of these functions to share information with one another. For example, the mobility management function may receive information about planned path(s) along which the robot(s) expect to travel when moving through the workspace and information about the robot(s) current location(s). Then, the mobility management function may utilize this information to configure the wireless access point(s) accordingly by, for example, reserving wireless resources for certain robot(s) at certain time(s), implementing a handover schedule of times at which each of the robot(s) is expected to handover communications from a particular wireless infrastructure device to another wireless infrastructure device, preparing contexts for the association process in advance of the robot(s)′ arrival to the handover location, ensuring sufficient coverage at certain time(s), prioritizing connectivity for certain robot(s) over other robot(s) at certain time(s), etc.

A mobility management function that is path-aware may be advantageous over current mobility management functions (e.g., in Wi-Fi, LTE, 5G, etc.), which typically consider only wireless-specific parameters (e.g. received signal strength, channel quality, etc.) for controlling whether, when, and how a handoff is to occur. Traditionally, the mobility function for a wireless network is a joint function between the mobile node (MN) (e.g., a robot) and the access infrastructure (e.g., a wireless access point) whereby the MN, based on its perceived signal characteristics (e.g., received signal strength (RSS), quality of service (QOS), etc.), decides to switch to a new wireless access point or wireless network. The MN may scan for a potential target wireless access point/network on which it may roam and then may negotiate a new connection (e.g., establishing an association and/or a context) with the target before switching data transport over to the new connection with the new wireless access point/network. This type of negotiation process is non-deterministic and the associated latency may be relatively high (e.g., 10 to 30 milliseconds), which may be especially problematic for a robot that requires a low-latency connection for quickly sending/receiving information that is processed at the edge/cloud. The path-aware mobility management function disclosed below may reduce this latency by, for example, preparing for the new connection in advance of when the robot is expected to encounter a handover event (e.g., the mobility controller may predict a roaming event and make arrangements with the target and the robot to make the handover process faster/seamless).

On the robot path planning function side of the system disclosed below, the path planner for the robot may utilize wireless connectivity information about the environment when planning a route for the robot so that, if necessary, the robot may circumvent locations that have been marked by the mobility management function as a location with reduced wireless performance (e.g., poor wireless coverage, high congestion, low data throughput, long handover latency, etc.), opting for other routes that may maintain a target level of wireless performance that is sufficient for the robot's planned tasks. Unlike current systems, where the path planner may simply use object avoidance to plan a safe path through the environment (e.g., divide the environment into a location grid, where each location is identified as occupied or not occupied), the path planner disclosed below may receive information about wireless connectivity throughout the environment (e.g., each location in the environment grid may be associated with corresponding wireless connectivity information) and plan a path and/or handover locations/times that may ensure a sufficient level of wireless connectivity along the path.

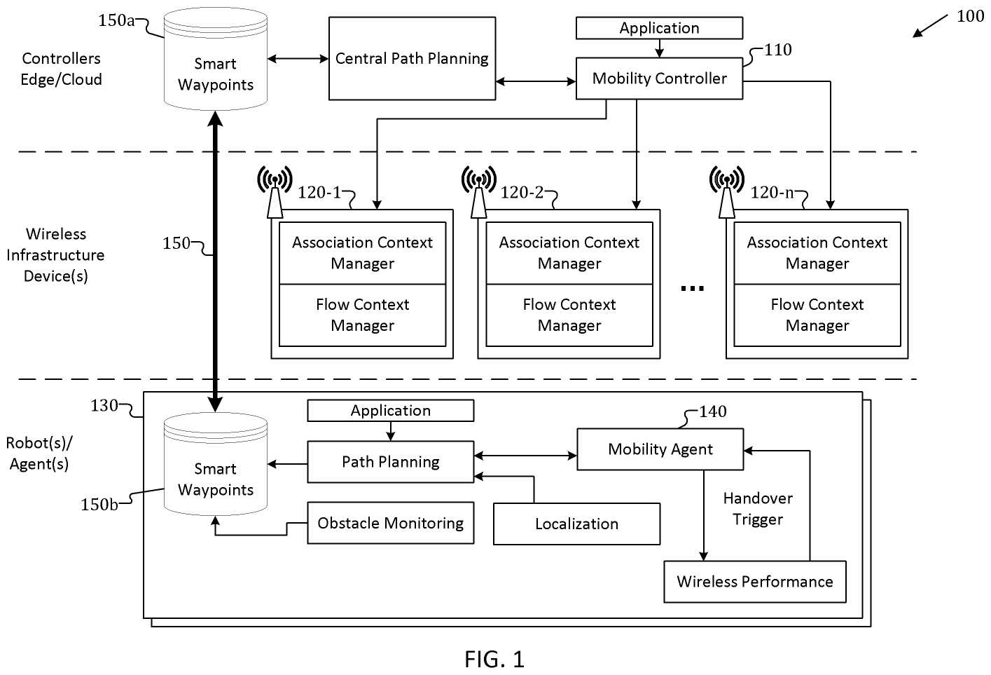

FIG. 1 shows a high level view of a mobility management and path planning system 100 that may provide an interface between the mobility management functions and path planning functions within an environment where a mobile unit (or multiple mobile units) (e.g. a robot or multiple robots) may require wireless connectivity supplied by one or more wireless infrastructure devices. FIG. 1 is divided (via dashed lines) into three main functional groups, where one functional group (in the upper-most portion of FIG. 1) may include the controllers (e.g., at the edge/cloud level) for the environment, a second functional group (in the middle portion of FIG. 1) may include the wireless infrastructure devices that may provide wireless connectivity to robots or other devices within the environment (e.g., wireless access points), and a third functional group (in the lower-most portion of FIG. 1) may include the mobile units (e.g., robots and their control agents) that may be moving about the environment and may be consuming wireless connectivity resources. As should be understood, the division of functional groups shown in FIG. 1 is merely exemplary, and the described functions need not necessarily be divided as shown in FIG. 1.

The functional group of controllers for the environment (shown in the upper-most portion of FIG. 1) may include a mobility controller 110 that may communicate with and control the various wireless infrastructure devices in the environment. For example, mobility controller 110 may send configuration messages to control any number of wireless infrastructure devices (e.g., wireless infrastructure device 120-1, wireless infrastructure device 120-2, and up to the nth wireless infrastructure device 120-n shown in the middle portion of FIG. 1). Each wireless infrastructure device may provide wireless communications resources according to one or more wireless protocols/standards (e.g., Wi-Fi (IEEE 802.11), Bluetooth, GSM, WCDMA, LTE, 5G, etc.), where an association context manager and/or flow context manager in each wireless infrastructure device may handle establishing, maintaining, and/or ending the wireless data connections with each mobile unit (e.g., with each of robot(s) 130 shown in the functional group in the lower-most portion of FIG. 1) in the environment and may coordinate with the mobility controller 110 to obtain configuration settings (e.g., via configuration messages). Configuration information for the infrastructure equipment may include any type of adjustable parameter for the particular wireless protocol used by each wireless infrastructure device, including, for example, antenna directivity, channel configurations, modulation and coding schemes, output power, maximum user capacity, etc.

Any number of robot(s) 130 (e.g., mobile units) may operate in the environment and may utilize the wireless connectivity provided by any of the wireless infrastructure devices (e.g., wireless infrastructure devices 120-1, 120-2, . . . 120-n). Each of the robot(s) 130 may be assisted by a mobility agent 140 (e.g., as part of a path planning circuit) that may coordinate path planning with wireless connectivity information. For example, the mobility agent 140 may, based on the destinations or waypoints along a planned route, determine a handoff trigger (e.g., a time or location at which the robot(s) 130 should initiate a handover from one wireless infrastructure device to another), a list of wireless infrastructure devices that the robot(s) 130 should use at each waypoint or when traveling between waypoints, configuration information for the wireless infrastructure devices with which the robot(s) 130 should use at each waypoint or when traveling between waypoints, etc.).

In particular, the robot(s) 130 (e.g. via its mobility agent 130) and the mobility controller 110 may share information over an interface 150 (e.g., communicate data over a network such as a wireless network using a wireless transceiver at the robot and at the mobility controller), including information about waypoints that may be part of the planned path for robot(s) 130. Each waypoint may be associated with additional information about the waypoint that is provided from the mobility controller 110 and/or from the robot(s) 130. This additional information together with the waypoint may be referred to as a “smart waypoint,” which may be stored in a memory (e.g., in a database of smart waypoints) at the mobility controller 110 (e.g., smart waypoints 150a) or at the robot(s) 130 (e.g., smart waypoints 150b), both, or at any other storage location to be shared over interface 150. In addition to waypoints that may be part of the planned path for robot(s) 130, the smart waypoints (e.g., smart waypoints 150a, 150b) may include any locations within the environment in which robot(s) 130 may move, irrespective of whether the location is on the current path of the robot(s) 130. For example, the environment area may be subdivided into a number of predefined locations (e.g., equal-sized areas/volumes (e.g., in a grid/cube pattern)), where each predefined location may be a possible location to which the robot(s) 130 may move (e.g., a possible waypoint that may be included when planning a path for robot(s) 130).

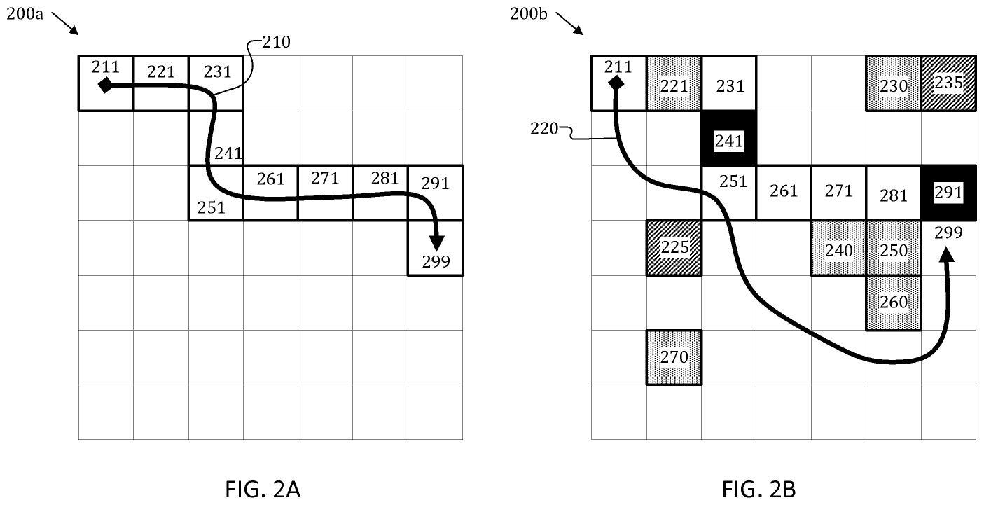

An example of such an environment (e.g., environment 200a, 200b) that has been subdivided into distinct locations is shown in FIGS. 2A and 2B. The environment 200a, 200b has been subdivided into a seven by seven grid of forty-nine locations, each of which are represented by a square area and may serve as a waypoint for a robot (e.g., one of robot(s) 130) that may move through environment 200a, 200b. As should be appreciated, this subdivision is merely exemplary and the locations may be defined by any shape, in any number of dimensions, and the shapes need not be uniform.

FIG. 2A also shows an exemplary path 210 of a robot (e.g., one of robot(s) 130), which indicates a planned path for how the robot plans to move through the environment 200a. In the example path 210 shown in FIG. 2A, the robot has planned movements from a starting location 211 to an ending location 299, moving through locations 221, 231, 241, 251, 261, 271, 281, and 291 along path 210. This grid of environment 200a may be understood as the “smart waypoints” discussed above because they contain information about the robot's planned path through the environment 200a. With reference to the discussion above, the robot may share path 210 as part of the smart waypoint information (e.g., information identifying the planned waypoint locations along with their associated timing) with the mobility controller (e.g., mobility controller 110) so that the mobility controller may, for example, determine and provide configuration information to the wireless infrastructure devices (e.g., wireless infrastructure devices 120-1, 120-2, and/or 120-n) that may be along the path 210.

In addition, the mobility controller (e.g., mobility controller 110) may enhance the smart waypoint information with wireless connectivity information. With reference to FIG. 2B, for example, environment 200b shows the same environment as environment 200a, except that the locations have been enhanced, in this example, with wireless connectivity information from the mobility controller. For example, the shading of each box of the grid of environment 200b indicates the associated wireless connectivity information for the corresponding location that may differ from location to location. No shading indicates, for example, a location in the environment 200b that has high quality wireless connectivity (e.g., at the current time or as expected at a particular time in the future). Cross-hatching, as shown in locations 225 and 235 indicates, in this example, locations in the environment 200b that may have limited capacity (e.g., because of high utilization/high traffic at the corresponding location at the current time or at an expected time in the future). Lightly shaded locations, such as in locations 221, 230, 240, 250, 260, and 270, indicate, in this example, that these locations may have slow data throughput (e.g., because of bandwidth limitations, low signal strengths, a noisy environment, etc.). Dark shaded locations, such as locations 241 and 291, indicate, in this example that the locations have no wireless connectivity. As should be appreciated, these are just examples of wireless connectivity information that may be stored as a smart waypoint, and the mobility controller may enhance the smart waypoint information for a given location (for a current time and/or as expected at future point(s) in time) with any type of information, including wireless transmission parameters such as channel quality, link reliability, data throughput, resource availability, transmission latency, etc.

In addition, the mobility controller may enhance the smart waypoint information for a given location with a probability that a robot will experience a handover/roaming event when moving between adjacent waypoints (e.g., along the planned path of the robot), the time at which the handover is likely to occur, a target infrastructure device or an ordered list of preferred infrastructure devices that is/are to be used at a given waypoint or between certain waypoints. The enhanced smart waypoint information may be pre-populated with an initial set of data that may be updated with actual experiences over time (e.g., using feedback from the actual wireless experiences of robot(s) moving in the environment), as the mobility controller learns the wireless conditions (e.g., channel conditions, fading profiles, dynamic patterns of objects, etc.) of the environment. In addition, the initial set of data may be based on historical information of the environment.

With reference to smart waypoints of FIGS. 2A-2B and the discussion above of FIG. 1, the mobility agent (e.g., mobility agent 140 of one of robot(s) 130) may utilize this enhanced waypoint information about wireless connectivity for path planning purposes. For example, after learning about the current or expected state of the wireless connectivity for waypoints along the robot's planned path 210 (shown in FIG. 2A), the mobility agent may revise the robot's planned path 210 to utilize waypoints that meet a predetermined criterion for the desired wireless connectivity as the robot moves. As shown in FIG. 2B, for example, based on the wireless connectivity information associated with each location, the mobility agent for the robot may determine that locations 221, 241, and 291 along the robot's previously planned path 210 (shown in FIG. 2A) do not meet the predetermined criteria for the robot's desired wireless connectivity.

Thus, the mobility agent may generate a new path 220 (shown in FIG. 2B) that includes locations with only high quality wireless connectivity, avoiding locations that have limited capacity, slow data throughput, and/or no wireless connectivity. In addition, as the robot moves about the environment (e.g., along its currently planned path), the mobility agent may receive updated information regarding current wireless configuration information from the mobility controller, and the mobility agent may re-plan the robot's route based on the updated information. As should also be appreciated, as the robot moves about the environment, it may report its actual wireless connectivity experience (e.g., throughput, availability, signal strength, latency, etc.) back to the mobility controller so that the mobility controller may, for example, adjust configuration parameters for the wireless infrastructure devices in the environment and/or update the wireless connectivity information stored with each waypoint. As should be appreciated, this may be collected from any of the robot(s) that may be moving about the environment and are capable of monitoring wireless connectivity experiences.

In addition, with reference to smart waypoints of FIGS. 2A-2B and the discussion above of FIG. 1, the mobility controller (e.g. mobility controller 110) may utilize the details of the robot's planned path that may be contained in the smart waypoint information to generate configuration messages for the wireless infrastructure device(s) by, for example, reserving wireless resources for certain robot(s) at certain time(s) based on the robot's path(s), implementing a handover schedule of times at which each of the robot(s) is expected to handover communications from a particular wireless infrastructure device to another wireless infrastructure device based on the path(s), preparing contexts for the association process in advance of the robot's handover to the new wireless infrastructure device, ensuring sufficient coverage at certain time(s) based on the path(s), prioritizing connectivity for certain robot(s) over other robot(s) at a certain time(s) based on the path(s), etc.

By providing this type of configuration information to the wireless infrastructure devices, the mobility controller may improve latency associated with the authentication/association process and the robot may experience a faster handover with lower latency. In addition, the mobility controller may also coordinate among wireless infrastructure devices so that, as the robot roams from one wireless infrastructure device to another, the mobility controller may ensure that the robot's communication data is forwarded from the robot's current wireless infrastructure device to the next planned wireless infrastructure device along the robot's planned path at the appropriate time, so that no robot data is lost during the handover process.

While the smart waypoints and interface has been described above with respect to a wireless environment with an access configuration based on a single node (e.g. indicating which one of a plurality of wireless access points of a network to use), this is not intended to be limiting and the wireless infrastructure configuration may include a multiple node configuration that involve multiple intermediate nodes or hops to provide connectivity from a starting point (e.g., the robot) to an ending point (the network processing/storage resource) that may involve multiple networks and/or multiple access points as a series of nodes between the starting point and ending point. In a multi-node configuration, the smart waypoints and interface may be used to control selection of any of the nodes in the series of nodes (e.g., selecting which node of available nodes to use as intermediate node(s) in the end-to-end connection, based on the path and current position of the robot, such that the overall connection may satisfy the predefined criteria of the robot's desired data connection (e.g., reliable and fast routing through multiple nodes).

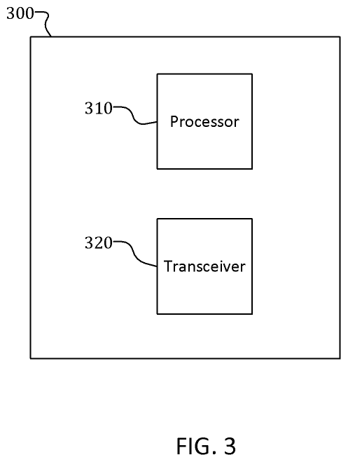

FIG. 3 is a schematic drawing illustrating a device 300 for a mobility management and path planning system that may provide an interface between the mobility management functions and path planning functions. The device 300 may include any of the features discussed above with respect to mobility management and path planning (e.g., mobility management and path planning system 100) and any of FIGS. 1, 2A, 2B. FIG. 3 may be implemented as a device, a system, a method, and/or a computer readable medium that, when executed, performs the features of the mobility management and path planning system described above. It should be understood that device 300 is only an example, and other configurations may be possible that include, for example, different components or additional components.

Device 300 includes a processor 310. In addition to or in combination with any of the features described in this or the following four paragraphs, processor 310 of device 300 is configured to receive (e.g., via a receiver and/or transceiver 320) an expected location into which a robot plans to move at a predefined time. In addition to or in combination with any of the features described in this or the following four paragraphs, processor 310 is further configured to determine, based on the expected location and a current location of the robot, an infrastructure configuration for a wireless infrastructure device that provide wireless connectivity at the expected location. In addition to or in combination with any of the features described in this or the following four paragraphs, processor 310 is further configured to generate a message to configure the wireless infrastructure device at the predefined time according to the infrastructure configuration.

Furthermore, in addition to or in combination with any one of the features of this and/or the preceding paragraph with respect to device 300, the infrastructure configuration may include a reservation of wireless resources on the wireless infrastructure device for use by the robot at the predefined time. Furthermore, in addition to or in combination with any one of the features of this and/or the preceding paragraph with respect to device 300, the infrastructure configuration may include an antenna directivity, an output power, or a maximum user capacity of the wireless infrastructure device. Furthermore, in addition to or in combination with any one of the features of this and/or the preceding paragraph with respect to device 300, processor 310 may be further configured to forward to the wireless infrastructure device data intended for the robot from a current wireless infrastructure device with which the robot is configured to wirelessly communicate at the current location. Furthermore, in addition to or in combination with any one of the features of this and/or the preceding paragraph with respect to device 300, the wireless infrastructure device may include a wireless access point that operate according to a wireless communication standard (e.g., IEEE 802.11, LTE, 5G, etc.).

Furthermore, in addition to or in combination with any one of the features of this and/or the preceding two paragraphs with respect to device 300, the message may include robot information for authentication and association of the robot with the wireless infrastructure device. Furthermore, in addition to or in combination with any one of the features of this and/or the preceding two paragraphs with respect to device 300, the expected location may be associated with a probability of a handover event from another wireless infrastructure device as the robot moves to the expected location, processor 310 may be further configured to determine the infrastructure configuration based on the probability. Furthermore, in addition to or in combination with any one of the features of this and/or the preceding two paragraphs with respect to device 300, the expected location may be one of a series of waypoints along an expected path of the robot, processor 310 may be further configured to determine, based on the series of waypoints along the expected path, a target wireless infrastructure device from among a plurality of wireless infrastructure devices, wherein the target wireless infrastructure device is to be used by the robot for each waypoint and as the robot moves along the expected path.

Furthermore, in addition to or in combination with any one of the features of this and/or the preceding three paragraphs with respect to device 300, processor 310 may be further configured to receive (e.g., via a receiver and/or transceiver 320) a plurality of expected paths from a plurality of robots. Furthermore, in addition to or in combination with any one of the features of this and/or the preceding three paragraphs with respect to device 300, processor 310 may be further configured to determine, further based on the plurality of expected paths, the infrastructure configuration for the wireless infrastructure device and other wireless infrastructure devices, wherein the infrastructure configuration includes a handover schedule for each robot of the plurality of robots, wherein the corresponding handover schedule indicates a time at which the each robot is to handoff wireless communications between the wireless infrastructure devices and one of the other wireless infrastructure devices. Furthermore, in addition to or in combination with any one of the features of this and/or the preceding three paragraphs with respect to device 300, the expected location may be associated with a plurality of wireless infrastructure devices that serve the expected location, processor 310 may be further configured to select one of the plurality of wireless infrastructure devices as the wireless infrastructure device based on a corresponding transmission parameter for each of the plurality of wireless infrastructure devices at the expected location.

Furthermore, in addition to or in combination with any one of the features of this and/or the preceding four paragraphs with respect to device 300, the corresponding transmission parameter may include at least one of a wireless channel quality, a wireless link reliability, a data throughput, a wireless resource availability, and a wireless transmission latency. Furthermore, in addition to or in combination with any one of the features of this and/or the preceding four paragraphs with respect to device 300, processor 310 may be further configured to determine the corresponding transmission parameter based on a database of historical transmission parameters for the expected location. Furthermore, in addition to or in combination with any one of the features of this and/or the preceding four paragraphs with respect to device 300, processor 310 may be further configured to update the database of historical transmission parameters for the expected location based on a current measurement of the corresponding transmission parameter.

In addition to or in combination with the configuration for device 300 above, device 300 includes a processor 310. In addition to or in combination with any of the features described in this or the following four paragraphs, processor 310 of device 300 is configured to receive (e.g., via a receiver and/or transceiver 320) wireless connectivity information about locations in an environment in which a robot may operate. In addition to or in combination with any of the features described in this or the following three paragraphs, processor 310 is further configured to determine, based on the wireless connectivity information, waypoints in a planned path for the robot from among the locations in the environment. In addition to or in combination with any of the features described in this or the following three paragraphs, processor 310 is further configured to generate movement instructions for the robot to move along the planned path through each of the waypoints.

Furthermore, in addition to or in combination with any one of the features of this and/or the preceding paragraph with respect to device 300, processor 310 may be further configured to determine, for each waypoint, a corresponding target wireless infrastructure device to be used by the robot at the waypoint, wherein the corresponding target wireless infrastructure device is based on the wireless connectivity information and selected from among a plurality of wireless infrastructure devices that serve the environment. Furthermore, in addition to or in combination with any one of the features of this and/or the preceding paragraph with respect to device 300, the wireless connectivity information may include corresponding transmission parameters at each location of the locations in the environment, wherein the corresponding transmission parameters include at least one of a wireless channel quality, a wireless link reliability, a data throughput, a wireless resource availability, and a wireless transmission latency at the location. Furthermore, in addition to or in combination with any one of the features of this and/or the preceding paragraph with respect to device 300, processor 310 may be further configured to receive (e.g., via a receiver and/or transceiver 320) a message from a mobility controller with updated connectivity information about at least one location in the planned path, wherein processor 310 may be further configured to update the waypoints based on the updated connectivity information.

Furthermore, in addition to or in combination with any one of the features of this and/or the preceding two paragraphs with respect to device 300, processor 310 may be further configured to schedule a time for a wireless communication handover from a selected one wireless infrastructure device for wireless communications of the robot at a waypoint of the waypoints to a selected other wireless infrastructure device for wireless communications of the robot at a subsequent waypoint of the waypoints location. Furthermore, in addition to or in combination with any one of the features of this and/or the preceding two paragraphs with respect to device 300, processor 310 may be further configured to request, based on the planned path, a reservation of wireless resources on a wireless infrastructure device for use by the robot at a waypoint from among the waypoints at a predefined time. Furthermore, in addition to or in combination with any one of the features of this and/or the preceding two paragraphs with respect to device 300, processor 310 may be further configured to transmit (e.g., via a transmitter and/or transceiver 320) robot information for authentication and association of the robot with a wireless infrastructure device for use by the robot at a waypoint from among the waypoints along the planned path.

Furthermore, in addition to or in combination with any one of the features of this and/or the preceding three paragraphs with respect to device 300, processor 310 may be further configured to transmit (e.g., via a transmitter and/or transceiver 320) wireless transmission experience information about actual wireless transmissions experienced by the robot along the planned path. Furthermore, in addition to or in combination with any one of the features of this and/or the preceding three paragraphs with respect to device 300, the wireless transmission experience information may include at least one of wireless channel quality information, wireless link reliability information, data throughput information, wireless resource availability information, and wireless transmission latency information. Furthermore, in addition to or in combination with any one of the features of this and/or the preceding three paragraphs with respect to device 300, processor 310 may be further configured to transmit (e.g., via a transmitter and/or transceiver 320) the waypoints along the planned path and receive (e.g., via a receiver and/or transceiver 320) a handover schedule for wireless infrastructure devices along the planned path, wherein the handover schedule is based on the waypoints.

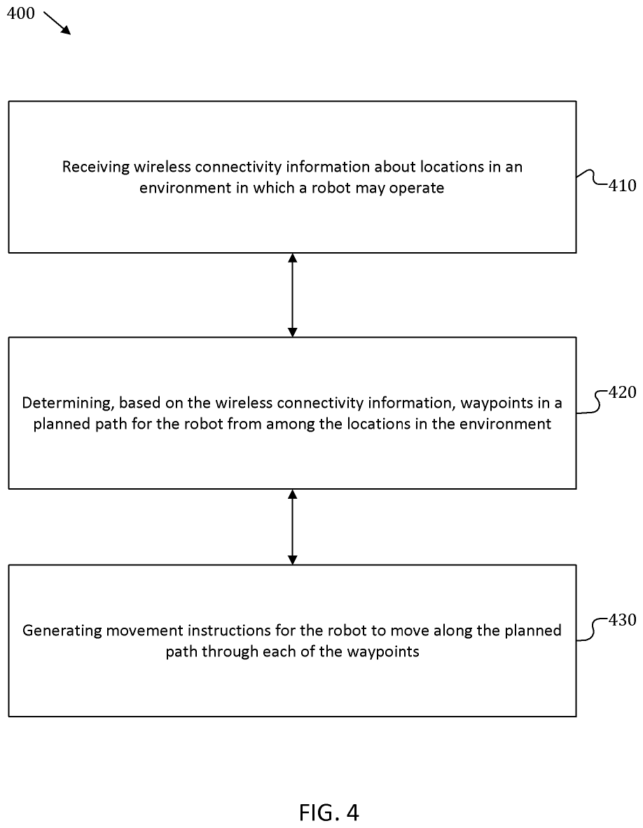

FIG. 4 depicts a schematic flow diagram of a method 400 for mobility management and path planning system that may provide an interface between the mobility management functions and path planning functions. Method 400 may implement any of the features described above with respect to mobility management and path planning system 100 and any of FIGS. 1-3.

Method 400 includes, in 410, receiving (e.g., via a receiver and/or transceiver 320) wireless connectivity information about locations in an environment in which a robot may operate. Method 400 also includes, in 420, determining, based on the wireless connectivity information, waypoints in a planned path for the robot from among the locations in the environment. Method 400 also includes, in 430, generating movement instructions for the robot to move along the planned path through each of the waypoints.

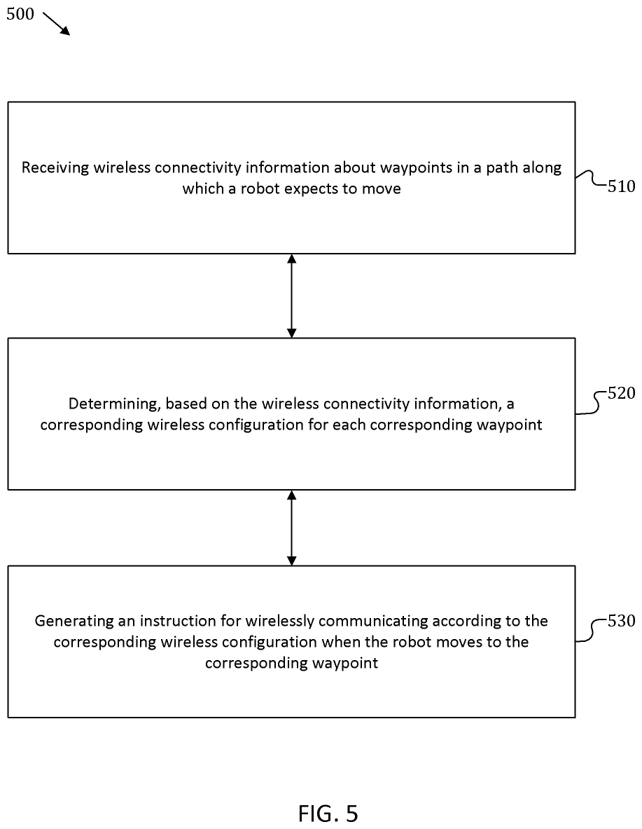

FIG. 5 depicts a schematic flow diagram of a method 500 for mobility management and path planning system that may provide an interface between the mobility management functions and path planning functions. Method 500 may implement any of the features described above with respect to mobility management and path planning system 100 and any of FIGS. 1-4.

Method 500 includes, in 510, receiving wireless connectivity information about waypoints in a path along which a robot expects to move. Method 500 also includes, in 520, determining, based on the wireless connectivity information, a corresponding wireless configuration for each corresponding waypoint. Method 500 also includes, in 530, generating an instruction for wirelessly communicating according to the corresponding wireless configuration when the robot moves to the corresponding waypoint.

In the following, various examples are provided that may include one or more aspects described above with reference to mobility management and path planning system 100, method 400, method 500, and any of FIGS. 1-5. The examples provided in relation to the devices may apply also to the described method(s), and vice versa.

Example 1 is a mobility controller including a processor configured to receive (e.g., via a receiver and/or transceiver) an expected location into which a robot plans to move at a predefined time. The mobility controller is also configured to determine, based on the expected location and a current location of the robot, an infrastructure configuration for a wireless infrastructure device that provide wireless connectivity at the expected location. The mobility controller is also configured to generate a message to configure the wireless infrastructure device at the predefined time according to the infrastructure configuration.

Example 2 is the mobility controller of example 1, wherein the infrastructure configuration includes a reservation of wireless resources on the wireless infrastructure device for use by the robot at the predefined time.

Example 3 is the mobility controller of either of examples 1 or 2, wherein the infrastructure configuration includes an antenna directivity, an output power, or a maximum user capacity of the wireless infrastructure device.

Example 4 is the mobility controller of any one of examples 1 to 3, wherein the processor is further configured to forward to the wireless infrastructure device data intended for the robot from a current wireless infrastructure device with which the robot is configured to wirelessly communicate at the current location.

Example 5 is the mobility controller of any one of examples 1 to 4, wherein the wireless infrastructure device includes a wireless access point that operate according to a wireless communication standard (e.g., IEEE 802.11, LTE, 5G, etc.).

Example 6 is the mobility controller of any one of examples 1 to 5, wherein the message includes robot information for authentication and association of the robot with the wireless infrastructure device.

Example 7 is the mobility controller of any one of examples 1 to 6, wherein the expected location is associated with a probability of a handover event from another wireless infrastructure device as the robot moves to the expected location, wherein the processor is further configured to determine the infrastructure configuration based on the probability.

Example 8 is the mobility controller of any one of examples 1 to 7, wherein the expected location is one of a series of waypoints along an expected path of the robot, wherein the processor is further configured to determine, based on the series of waypoints along the expected path, a target wireless infrastructure device from among a plurality of wireless infrastructure devices, wherein the target wireless infrastructure device is to be used by the robot for each waypoint and as the robot moves along the expected path.

Example 9 is the mobility controller of any one of examples 1 to 8, wherein the processor is further configured to receive (e.g., via a receiver and/or transceiver) a plurality of expected paths from a plurality of robots. The processor is further configured to determine, further based on the plurality of expected paths, the infrastructure configuration for the wireless infrastructure device and other wireless infrastructure devices, wherein the infrastructure configuration includes a handover schedule for each robot of the plurality of robots, wherein the corresponding handover schedule indicates a time at which the each robot is to handoff wireless communications between the wireless infrastructure devices and one of the other wireless infrastructure devices.

Example 10 is the mobility controller of any one of examples 1 to 9, wherein the expected location is associated with a plurality of wireless infrastructure devices that serve the expected location, wherein the processor is further configured to select one of the plurality of wireless infrastructure devices as the wireless infrastructure device based on a corresponding transmission parameter for each of the plurality of wireless infrastructure devices at the expected location.

Example 11 is the mobility controller of example 10, wherein the corresponding transmission parameter includes at least one of a wireless channel quality, a wireless link reliability, a data throughput, a wireless resource availability, and a wireless transmission latency.

Example 12 is the mobility controller of any one of examples 10 to 11, wherein the processor is further configured to determine the corresponding transmission parameter based on a database of historical transmission parameters for the expected location.

Example 13 is the mobility controller of any one of examples 10 to 12, wherein the processor is further configured to update the database of historical transmission parameters for the expected location based on a current measurement of the corresponding transmission parameter.

Example 14 is a device including a processor configured to receive (e.g., via a receiver and/or transceiver) wireless connectivity information about locations in an environment in which a robot may operate. The processor is further configured to determine, based on the wireless connectivity information, waypoints in a planned path for the robot from among the locations in the environment. The processor is further configured to generate movement instructions for the robot to move along the planned path through each of the waypoints.

Example 15 is the device of example 14, wherein the processor is further configured to determine, for each waypoint, a corresponding target wireless infrastructure device to be used by the robot at the waypoint, wherein the corresponding target wireless infrastructure device is based on the wireless connectivity information and selected from among a plurality of wireless infrastructure devices that serve the environment.

Example 16 is the device of either of examples 14 or 15, wherein the wireless connectivity information includes corresponding transmission parameters at each location of the locations in the environment, wherein the corresponding transmission parameters include at least one of a wireless channel quality, a wireless link reliability, a data throughput, a wireless resource availability, and a wireless transmission latency at the location.

Example 17 is the device of any one of examples 14 to 16, wherein the processor is further configured to receive (e.g., via a receiver and/or transceiver) a message from a mobility controller with updated connectivity information about at least one location in the planned path, wherein the processor is further configured to update the waypoints based on the updated connectivity information.

Example 18 is the device of any one of examples 14 to 17, wherein the processor is further configured to schedule a time for a wireless communication handover from a selected one wireless infrastructure device for wireless communications of the robot at a waypoint of the waypoints to a selected other wireless infrastructure device for wireless communications of the robot at a subsequent waypoint of the waypoints location.

Example 19 is the device of any one of examples 14 to 18, wherein the processor is further configured to request, based on the planned path, a reservation of wireless resources on a wireless infrastructure device for use by the robot at a waypoint from among the waypoints at a predefined time.

Example 20 is the device of any one of examples 14 to 19, wherein the processor is further configured to transmit (e.g., via a transmitter and/or transceiver) robot information for authentication and association of the robot with a wireless infrastructure device for use by the robot at a waypoint from among the waypoints along the planned path.

Example 21 is the device of any one of examples 14 to 20, wherein the processor is further configured to transmit (e.g., via a transmitter and/or transceiver) wireless transmission experience information about actual wireless transmissions experienced by the robot along the planned path.

Example 22 is the device of example 21, wherein the wireless transmission experience information includes at least one of wireless channel quality information, wireless link reliability information, data throughput information, wireless resource availability information, and wireless transmission latency information.

Example 23 is the device of any one of examples 14 to 22, wherein the processor is further configured to transmit (e.g., via a transmitter and/or transceiver) the waypoints along the planned path and receive (e.g., via a receiver and/or transceiver) a handover schedule for wireless infrastructure devices along the planned path, wherein the handover schedule is based on the waypoints.

Example 24 is a robot that includes a wireless transceiver configured to receive wireless connectivity information about waypoints in a path along which the robot expects to move. The robot also includes a path planning circuit in communication with the wireless transceiver, the path planning circuit configured to determine, based on the wireless connectivity information, a corresponding wireless configuration for each corresponding waypoint. The path planning circuit is further configured to generate an instruction for the wireless transceiver to wirelessly communicate according to the corresponding wireless configuration when the robot moves to the corresponding waypoint.

Example 25 is the robot of example 24, wherein the corresponding wireless configuration includes a target wireless infrastructure device for the robot to use for wireless communications at the corresponding waypoint and a time to perform a handover of the wireless communications to the target wireless infrastructure device.

Example 26 is the robot of example 25, wherein the handover of the wireless communications to the target wireless infrastructure device is from a previous wireless infrastructure device associated with a previous waypoint in the path.

Example 27 is the robot of any one of examples 24 to 26, wherein the wireless connectivity information includes at least one of a wireless channel quality, a wireless link reliability, a data throughput, a wireless resource availability, and a wireless transmission latency along the path.

Example 28 is the robot of any one of examples 24 to 27, wherein the path planning circuit is further configured to determine the waypoints in the path based on the wireless connectivity information.

Example 29 is the robot of any one of examples 24 to 28, wherein the wireless transceiver is further configured to receive a message from a mobility controller with updated wireless connectivity information about at least one waypoint in the path, wherein the path planning circuit is further configured to update at least one of the waypoints in the path based on the updated wireless connectivity information.

Example 30 is the robot of any one of examples 24 to 29, wherein the path planning circuit is further configured to schedule a time for a wireless communication handover from a selected one wireless infrastructure device for wireless communications of the robot along the path from a first waypoint of the waypoints to a selected other wireless infrastructure device for wireless communications of the robot at a subsequent waypoint of the waypoints.

Example 31 is the robot of any one of examples 24 to 30, wherein the wireless transceiver is further configured to transmit a message that requests, based on the planned path, a reservation of wireless resources on a wireless infrastructure device for use by the robot at a waypoint from among the waypoints at a predefined time.

Example 32 is the robot of any one of examples 24 to 31, wherein the wireless transceiver is further configured to transmit robot information for authentication and association of the robot with a wireless infrastructure device for use by the robot at a waypoint from among the waypoints along the planned path.

Example 33 is the robot of any one of examples 24 to 32, wherein the wireless transceiver is further configured to transmit wireless transmission experience information about actual wireless transmissions experienced by the robot along the planned path.

Example 34 is the robot of example 33, wherein the wireless transmission experience information includes at least one of wireless channel quality information, wireless link reliability information, data throughput information, wireless resource availability information, and wireless transmission latency information.

Example 35 is the robot of any one of examples 24 to 34, wherein the wireless transceiver is further configured to transmit the waypoints along the planned path and to receive a handover schedule for wireless infrastructure devices along the planned path, wherein the handover schedule is based on the waypoints.

Example 36 is method that includes receiving (e.g., via a receiver and/or transceiver) an expected location into which a robot plans to move at a predefined time. The method also includes determining, based on the expected location and a current location of the robot, an infrastructure configuration for a wireless infrastructure device that provide wireless connectivity at the expected location. The method also includes generating a message to configure the wireless infrastructure device at the predefined time according to the infrastructure configuration.

Example 37 is the method of example 36, wherein the infrastructure configuration includes a reservation of wireless resources on the wireless infrastructure device for use by the robot at the predefined time.

Example 38 is the method of either of examples 36 or 37, wherein the infrastructure configuration includes an antenna directivity, an output power, or a maximum user capacity of the wireless infrastructure device.

Example 39 is the method of any one of examples 36 to 38, wherein method also includes forwarding to the wireless infrastructure device data intended for the robot from a current wireless infrastructure device with which the robot is configured to wirelessly communicate at the current location.

Example 40 is the method of any one of examples 36 to 39, wherein the wireless infrastructure device includes a wireless access point that operate according to a wireless communication standard (e.g., IEEE 802.11, LTE, 5G, etc.).

Example 41 is the method of any one of examples 36 to 40, wherein the message includes robot information for authentication and association of the robot with the wireless infrastructure device.

Example 42 is the method of any one of examples 36 to 41, wherein the expected location is associated with a probability of a handover event from another wireless infrastructure device as the robot moves to the expected location, wherein the method also includes determining the infrastructure configuration based on the probability.

Example 43 is the method of any one of examples 36 to 42, wherein the expected location is one of a series of waypoints along an expected path of the robot, wherein method also includes determining, based on the series of waypoints along the expected path, a target wireless infrastructure device from among a plurality of wireless infrastructure devices, wherein the target wireless infrastructure device is to be used by the robot for each waypoint and as the robot moves along the expected path.

Example 44 is the method of any one of examples 36 to 43, wherein the method also includes receiving (e.g., via a receiver and/or transceiver) a plurality of expected paths from a plurality of robots. The method also includes determining, further based on the plurality of expected paths, the infrastructure configuration for the wireless infrastructure device and other wireless infrastructure devices, wherein the infrastructure configuration includes a handover schedule for each robot of the plurality of robots, wherein the corresponding handover schedule indicates a time at which the each robot is to handoff wireless communications between the wireless infrastructure devices and one of the other wireless infrastructure devices.

Example 45 is the method of any one of examples 36 to 44, wherein the expected location is associated with a plurality of wireless infrastructure devices that serve the expected location, wherein the method also includes selecting one of the plurality of wireless infrastructure devices as the wireless infrastructure device based on a corresponding transmission parameter for each of the plurality of wireless infrastructure devices at the expected location.

Example 46 is the method of example 45, wherein the corresponding transmission parameter includes at least one of a wireless channel quality, a wireless link reliability, a data throughput, a wireless resource availability, and a wireless transmission latency.

Example 47 is the method of any one of examples 45 to 46, wherein the method also includes determining the corresponding transmission parameter based on a database of historical transmission parameters for the expected location.

Example 48 is the method of any one of examples 45 to 47, wherein the method also includes updating the database of historical transmission parameters for the expected location based on a current measurement of the corresponding transmission parameter.

Example 49 is a method that includes receiving (e.g., via a receiver and/or transceiver) wireless connectivity information about locations in an environment in which a robot may operate. The method also includes determining, based on the wireless connectivity information, waypoints in a planned path for the robot from among the locations in the environment. The method also includes generating movement instructions for the robot to move along the planned path through each of the waypoints.

Example 50 is the method of example 49, wherein the method also includes determining, for each waypoint, a corresponding target wireless infrastructure device to be used by the robot at the waypoint, wherein the corresponding target wireless infrastructure device is based on the wireless connectivity information and selected from among a plurality of wireless infrastructure devices that serve the environment.

Example 51 is the method of either of examples 49 or 50, wherein the wireless connectivity information includes corresponding transmission parameters at each location of the locations in the environment, wherein the corresponding transmission parameters include at least one of a wireless channel quality, a wireless link reliability, a data throughput, a wireless resource availability, and a wireless transmission latency at the location.

Example 52 is the method of any one of examples 49 to 51, wherein the method also includes receiving (e.g., via a receiver and/or transceiver) a message from a mobility controller with updated connectivity information about at least one location in the planned path, wherein the method also includes updating the waypoints based on the updated connectivity information.

Example 53 is the method of any one of examples 49 to 52, wherein the method also includes scheduling a time for a wireless communication handover from a selected one wireless infrastructure device for wireless communications of the robot at a waypoint of the waypoints to a selected other wireless infrastructure device for wireless communications of the robot at a subsequent waypoint of the waypoints location.

Example 54 is the method of any one of examples 49 to 53, wherein the method also includes requesting, based on the planned path, a reservation of wireless resources on a wireless infrastructure device for use by the robot at a waypoint from among the waypoints at a predefined time.

Example 55 is the method of any one of examples 49 to 54, wherein the method also includes transmitting (e.g., via a transmitter and/or transceiver) robot information for authentication and association of the robot with a wireless infrastructure device for use by the robot at a waypoint from among the waypoints along the planned path.

Example 56 is the method of any one of examples 49 to 55, wherein the method also includes transmitting (e.g., via a transmitter and/or transceiver) wireless transmission experience information about actual wireless transmissions experienced by the robot along the planned path.

Example 57 is the method of example 56, wherein the wireless transmission experience information includes at least one of wireless channel quality information, wireless link reliability information, data throughput information, wireless resource availability information, and wireless transmission latency information.

Example 58 is the method of any one of examples 49 to 57, wherein the method also includes transmitting (e.g., via a transmitter and/or transceiver) the waypoints along the planned path and receive (e.g., via a receiver and/or transceiver) a handover schedule for wireless infrastructure devices along the planned path, wherein the handover schedule is based on the waypoints.

Example 59 is a method that includes receiving wireless connectivity information about waypoints in a path along which a robot expects to move. The method also includes determining, based on the wireless connectivity information, a corresponding wireless configuration for each corresponding waypoint. The method further includes generating an instruction for wirelessly communicating according to the corresponding wireless configuration when the robot moves to the corresponding waypoint.

Example 60 is the method of example 59, wherein the corresponding wireless configuration includes a target wireless infrastructure device for the robot to use for wireless communications at the corresponding waypoint and a time to perform a handover of the wireless communications to the target wireless infrastructure device.

Example 61 is the method of example 60, wherein the handover of the wireless communications to the target wireless infrastructure device is from a previous wireless infrastructure device associated with a previous waypoint in the path.

Example 62 is the method of any one of examples 59 to 61, wherein the wireless connectivity information includes at least one of a wireless channel quality, a wireless link reliability, a data throughput, a wireless resource availability, and a wireless transmission latency along the path.

Example 63 is the method of any one of examples 59 to 62, wherein the method also includes determining the waypoints in the path based on the wireless connectivity information.

Example 64 is the method of any one of examples 59 to 63, wherein the method also includes receiving a message from a mobility controller with updated wireless connectivity information about at least one waypoint in the path, wherein the method also includes updating at least one of the waypoints in the path based on the updated wireless connectivity information.

Example 65 is the method of any one of examples 59 to 64, wherein the method also includes scheduling a time for a wireless communication handover from a selected one wireless infrastructure device for wireless communications of the robot along the path from a first waypoint of the waypoints to a selected other wireless infrastructure device for wireless communications of the robot at a subsequent waypoint of the waypoints.

Example 66 is the method of any one of examples 59 to 65, wherein the method further includes transmitting a message that requests, based on the planned path, a reservation of wireless resources on a wireless infrastructure device for use by the robot at a waypoint from among the waypoints at a predefined time.

Example 67 is the method of any one of examples 59 to 66, wherein the method also includes transmitting robot information for authentication and association of the robot with a wireless infrastructure device for use by the robot at a waypoint from among the waypoints along the planned path.

Example 68 is the method of any one of examples 59 to 67, wherein the method also includes transmitting wireless transmission experience information about actual wireless transmissions experienced by the robot along the planned path.

Example 69 is the method of example 68, wherein the wireless transmission experience information includes at least one of wireless channel quality information, wireless link reliability information, data throughput information, wireless resource availability information, and wireless transmission latency information.

Example 70 is the method of any one of examples 59 to 69, wherein the method also includes transmitting the waypoints along the planned path and to receive a handover schedule for wireless infrastructure devices along the planned path, wherein the handover schedule is based on the waypoints.

Example 71 is a device that includes a means for receiving (e.g., via a receiver and/or transceiver) an expected location into which a robot plans to move at a predefined time. The device also includes a means for determining, based on the expected location and a current location of the robot, an infrastructure configuration for a wireless infrastructure device that provide wireless connectivity at the expected location. The device also includes a means for generating a message to configure the wireless infrastructure device at the predefined time according to the infrastructure configuration.

Example 72 is the device of example 71, wherein the infrastructure configuration includes a reservation of wireless resources on the wireless infrastructure device for use by the robot at the predefined time.

Example 73 is the device of either of examples 71 or 72, wherein the infrastructure configuration includes an antenna directivity, an output power, or a maximum user capacity of the wireless infrastructure device.

Example 74 is the device of any one of examples 71 to 73, wherein device also includes a means for forwarding to the wireless infrastructure device data intended for the robot from a current wireless infrastructure device with which the robot is configured to wirelessly communicate at the current location.

Example 75 is the device of any one of examples 71 to 74, wherein the wireless infrastructure device includes a wireless access point that operate according to a wireless communication standard (e.g., IEEE 802.11, LTE, 5G, etc.).

Example 76 is the device of any one of examples 71 to 75, wherein the message includes robot information for authentication and association of the robot with the wireless infrastructure device.

Example 77 is the device of any one of examples 71 to 76, wherein the expected location is associated with a probability of a handover event from another wireless infrastructure device as the robot moves to the expected location, wherein the device also includes a means for determining the infrastructure configuration based on the probability.

Example 78 is the device of any one of examples 71 to 77, wherein the expected location is one of a series of waypoints along an expected path of the robot, wherein device also includes a means for determining, based on the series of waypoints along the expected path, a target wireless infrastructure device from among a plurality of wireless infrastructure devices, wherein the target wireless infrastructure device is to be used by the robot for each waypoint and as the robot moves along the expected path.

Example 79 is the device of any one of examples 71 to 78, wherein the device also includes a means for receiving (e.g., via a receiver and/or transceiver) a plurality of expected paths from a plurality of robots. The device also includes a means for determining, further based on the plurality of expected paths, the infrastructure configuration for the wireless infrastructure device and other wireless infrastructure devices, wherein the infrastructure configuration includes a handover schedule for each robot of the plurality of robots, wherein the corresponding handover schedule indicates a time at which the each robot is to handoff wireless communications between the wireless infrastructure devices and one of the other wireless infrastructure devices.

Example 80 is the device of any one of examples 71 to 79, wherein the expected location is associated with a plurality of wireless infrastructure devices that serve the expected location, wherein the device also includes a means for selecting one of the plurality of wireless infrastructure devices as the wireless infrastructure device based on a corresponding transmission parameter for each of the plurality of wireless infrastructure devices at the expected location.

Example 81 is the device of example 80, wherein the corresponding transmission parameter includes at least one of a wireless channel quality, a wireless link reliability, a data throughput, a wireless resource availability, and a wireless transmission latency.

Example 82 is the device of any one of examples 80 to 81, wherein the device also includes a means for determining the corresponding transmission parameter based on a database of historical transmission parameters for the expected location.

Example 83 is the device of any one of examples 80 to 82, wherein the device also includes a means for updating the database of historical transmission parameters for the expected location based on a current measurement of the corresponding transmission parameter.

Example 84 is a device that includes a means for receiving (e.g., via a receiver and/or transceiver) wireless connectivity information about locations in an environment in which a robot may operate. The device also includes a means for determining, based on the wireless connectivity information, waypoints in a planned path for the robot from among the locations in the environment. The device also includes a means for generating movement instructions for the robot to move along the planned path through each of the waypoints.

Example 85 is the device of example 84, wherein the device also includes a means for determining, for each waypoint, a corresponding target wireless infrastructure device to be used by the robot at the waypoint, wherein the corresponding target wireless infrastructure device is based on the wireless connectivity information and selected from among a plurality of wireless infrastructure devices that serve the environment.

Example 86 is the device of either of examples 84 or 85, wherein the wireless connectivity information includes corresponding transmission parameters at each location of the locations in the environment, wherein the corresponding transmission parameters include at least one of a wireless channel quality, a wireless link reliability, a data throughput, a wireless resource availability, and a wireless transmission latency at the location.

Example 87 is the device of any one of examples 84 to 86, wherein the device also includes a means for receiving (e.g., via a receiver and/or transceiver) a message from a mobility controller with updated connectivity information about at least one location in the planned path, wherein the device also includes updating the waypoints based on the updated connectivity information.

Example 88 is the device of any one of examples 84 to 87, wherein the device also includes a means for scheduling a time for a wireless communication handover from a selected one wireless infrastructure device for wireless communications of the robot at a waypoint of the waypoints to a selected other wireless infrastructure device for wireless communications of the robot at a subsequent waypoint of the waypoints location.

Example 89 is the device of any one of examples 84 to 88, wherein the device also includes a means for requesting, based on the planned path. a reservation of wireless resources on a wireless infrastructure device for use by the robot at a waypoint from among the waypoints at a predefined time.

Example 90 is the device of any one of examples 84 to 89, wherein the device also includes a means for transmitting (e.g., via a transmitter and/or transceiver) robot information for authentication and association of the robot with a wireless infrastructure device for use by the robot at a waypoint from among the waypoints along the planned path.

Example 91 is the device of any one of examples 84 to 90, wherein the device also includes a means for transmitting (e.g., via a transmitter and/or transceiver) wireless transmission experience information about actual wireless transmissions experienced by the robot along the planned path.

Example 92 is the device of example 91, wherein the wireless transmission experience information includes at least one of wireless channel quality information, wireless link reliability information, data throughput information, wireless resource availability information, and wireless transmission latency information.

Example 93 is the device of any one of examples 84 to 92, wherein the device also includes a means for transmitting (e.g., via a transmitter and/or transceiver) the waypoints along the planned path and receive (e.g., via a receiver and/or transceiver) a handover schedule for wireless infrastructure devices along the planned path, wherein the handover schedule is based on the waypoints.

Example 94 is a device that includes a means for receiving wireless connectivity information about waypoints in a path along which a robot expects to move. The device also includes a means for determining, based on the wireless connectivity information, a corresponding wireless configuration for each corresponding waypoint. The device further includes a means for generating an instruction for wirelessly communicating according to the corresponding wireless configuration when the robot moves to the corresponding waypoint.

Example 95 is the device of example 94, wherein the corresponding wireless configuration includes a target wireless infrastructure device for the robot to use for wireless communications at the corresponding waypoint and a time to perform a handover of the wireless communications to the target wireless infrastructure device.

Example 96 is the device of example 95, wherein the handover of the wireless communications to the target wireless infrastructure device is from a previous wireless infrastructure device associated with a previous waypoint in the path.

Example 97 is the device of any one of examples 94 to 96, wherein the wireless connectivity information includes at least one of a wireless channel quality, a wireless link reliability, a data throughput, a wireless resource availability, and a wireless transmission latency along the path.

Example 98 is the device of any one of examples 94 to 97, wherein the device also includes a means for determining the waypoints in the path based on the wireless connectivity information.

Example 99 is the device of any one of examples 94 to 98, wherein the device also includes a means for receiving a message from a mobility controller with updated wireless connectivity information about at least one waypoint in the path, wherein the device also includes a means for updating at least one of the waypoints in the path based on the updated wireless connectivity information.

Example 100 is the device of any one of examples 94 to 99, wherein the device also includes a means for scheduling a time for a wireless communication handover from a selected one wireless infrastructure device for wireless communications of the robot along the path from a first waypoint of the waypoints to a selected other wireless infrastructure device for wireless communications of the robot at a subsequent waypoint of the waypoints.

Example 101 is the device of any one of examples 94 to 100, wherein the device further includes a means for transmitting a message that requests, based on the planned path, a reservation of wireless resources on a wireless infrastructure device for use by the robot at a waypoint from among the waypoints at a predefined time.

Example 102 is the device of any one of examples 94 to 101, wherein the device also includes a means for transmitting robot information for authentication and association of the robot with a wireless infrastructure device for use by the robot at a waypoint from among the waypoints along the planned path.

Example 103 is the device of any one of examples 94 to 102, wherein the device also includes a means for transmitting wireless transmission experience information about actual wireless transmissions experienced by the robot along the planned path.

Example 104 is the device of example 103, wherein the wireless transmission experience information includes at least one of wireless channel quality information, wireless link reliability information, data throughput information, wireless resource availability information, and wireless transmission latency information.

Example 105 is the device of any one of examples 94 to 104, wherein the device also includes a means for transmitting the waypoints along the planned path and to receive a handover schedule for wireless infrastructure devices along the planned path, wherein the handover schedule is based on the waypoints.

Example 95 is a is a non-transitory computer readable medium that includes instructions, which if executed, cause one or more processors to receive (e.g., via a receiver and/or transceiver) an expected location into which a robot plans to move at a predefined time. The instructions also cause the one or more processors to determine, based on the expected location and a current location of the robot, an infrastructure configuration for a wireless infrastructure device that provide wireless connectivity at the expected location. The instructions also cause the one or more processors to configure the wireless infrastructure device at the predefined time according to the infrastructure configuration.

Example 96 is the non-transitory computer readable medium of example 95, wherein the infrastructure configuration includes a reservation of wireless resources on the wireless infrastructure device for use by the robot at the predefined time.

Example 97 is the non-transitory computer readable medium of either of examples 95 or 96, wherein the infrastructure configuration includes an antenna directivity, an output power, or a maximum user capacity of the wireless infrastructure device.

Example 98 is the non-transitory computer readable medium of any one of examples 95 to 97, wherein the instructions also cause the one or more processors to forward to the wireless infrastructure device data intended for the robot from a current wireless infrastructure device with which the robot is configured to wirelessly communicate at the current location.

Example 99 is the non-transitory computer readable medium of any one of examples 95 to 98, wherein the wireless infrastructure device includes a wireless access point that operate according to a wireless communication standard (e.g., IEEE 802.11, LTE, 5G, etc.).

Example 100 is the non-transitory computer readable medium of any one of examples 95 to 99, wherein the message includes robot information for authentication and association of the robot with the wireless infrastructure device.

Example 101 is the non-transitory computer readable medium of any one of examples 95 to 100, wherein the expected location is associated with a probability of a handover event from another wireless infrastructure device as the robot moves to the expected location, wherein the instructions also cause the one or more processors to determine the infrastructure configuration based on the probability.

Example 102 is the non-transitory computer readable medium of any one of examples 95 to 101, wherein the expected location is one of a series of waypoints along an expected path of the robot, wherein the processor is further configured to determine, based on the series of waypoints along the expected path, a target wireless infrastructure device from among a plurality of wireless infrastructure devices, wherein the target wireless infrastructure device is to be used by the robot for each waypoint and as the robot moves along the expected path.

Example 103 is the non-transitory computer readable medium of any one of examples 95 to 102, wherein the instructions also cause the one or more processors to receive (e.g., via a receiver and/or transceiver) a plurality of expected paths from a plurality of robots. The instructions also cause the one or more processors to determine, further based on the plurality of expected paths, the infrastructure configuration for the wireless infrastructure device and other wireless infrastructure devices, wherein the infrastructure configuration includes a handover schedule for each robot of the plurality of robots, wherein the corresponding handover schedule indicates a time at which the each robot is to handoff wireless communications between the wireless infrastructure devices and one of the other wireless infrastructure devices.

Example 104 is the non-transitory computer readable medium of any one of examples 95 to 103, wherein the expected location is associated with a plurality of wireless infrastructure devices that serve the expected location, wherein the processor is further configured to select one of the plurality of wireless infrastructure devices as the wireless infrastructure device based on a corresponding transmission parameter for each of the plurality of wireless infrastructure devices at the expected location.

Example 105 is the non-transitory computer readable medium of example 104, wherein the corresponding transmission parameter includes at least one of a wireless channel quality, a wireless link reliability, a data throughput, a wireless resource availability, and a wireless transmission latency.

Example 106 is the non-transitory computer readable medium of any one of examples 104 to 105, wherein the instructions also cause the one or more processors to determine the corresponding transmission parameter based on a database of historical transmission parameters for the expected location.

Example 107 is the non-transitory computer readable medium of any one of examples 104 to 106, wherein the instructions also cause the one or more processors to update the database of historical transmission parameters for the expected location based on a current measurement of the corresponding transmission parameter.

Example 108 is a is a non-transitory computer readable medium that includes instructions, which if executed, cause one or more processors to receive (e.g., via a receiver and/or transceiver) wireless connectivity information about locations in an environment in which a robot may operate. The instructions also cause the one or more processors to determine, based on the wireless connectivity information, waypoints in a planned path for the robot from among the locations in the environment. The instructions also cause the one or more processors to generate movement instructions for the robot to move along the planned path through each of the waypoints.

Example 109 is the non-transitory computer readable medium of example 108, wherein the instructions also cause the one or more processors to determine, for each waypoint, a corresponding target wireless infrastructure device to be used by the robot at the waypoint, wherein the corresponding target wireless infrastructure device is based on the wireless connectivity information and selected from among a plurality of wireless infrastructure devices that serve the environment.

Example 110 is the non-transitory computer readable medium of either of examples 108 or 109, wherein the wireless connectivity information includes corresponding transmission parameters at each location of the locations in the environment, wherein the corresponding transmission parameters include at least one of a wireless channel quality, a wireless link reliability, a data throughput, a wireless resource availability, and a wireless transmission latency at the location.

Example 111 is the non-transitory computer readable medium of any one of examples 108 to 110, wherein the instructions also cause the one or more processors to receive (e.g., via a receiver and/or transceiver) a message from a mobility controller with updated connectivity information about at least one location in the planned path, wherein the instructions also cause the one or more processors to update the waypoints based on the updated connectivity information.

Example 112 is the non-transitory computer readable medium of any one of examples 108 to 111, wherein the instructions also cause the one or more processors to schedule a time for a wireless communication handover from a selected one wireless infrastructure device for wireless communications of the robot at a waypoint of the waypoints to a selected other wireless infrastructure device for wireless communications of the robot at a subsequent waypoint of the waypoints location.

Example 113 is the non-transitory computer readable medium of any one of examples 108 to 112, wherein the instructions also cause the one or more processors to request, based on the planned path, a reservation of wireless resources on a wireless infrastructure device for use by the robot at a waypoint from among the waypoints at a predefined time.

Example 114 is the non-transitory computer readable medium of any one of examples 108 to 113, wherein the instructions also cause the one or more processors to transmit (e.g., via a transmitter and/or transceiver) robot information for authentication and association of the robot with a wireless infrastructure device for use by the robot at a waypoint from among the waypoints along the planned path.

Example 115 is the non-transitory computer readable medium of any one of examples 108 to 114, wherein the instructions also cause the one or more processors to transmit (e.g., via a transmitter and/or transceiver) wireless transmission experience information about actual wireless transmissions experienced by the robot along the planned path.

Example 116 is the non-transitory computer readable medium of example 115, wherein the wireless transmission experience information includes at least one of wireless channel quality information, wireless link reliability information, data throughput information, wireless resource availability information, and wireless transmission latency information.

Example 117 is the non-transitory computer readable medium of any one of examples 108 to 116, wherein the instructions also cause the one or more processors to transmit (e.g., via a transmitter and/or transceiver) the waypoints along the planned path and receive (e.g., via a receiver and/or transceiver) a handover schedule for wireless infrastructure devices along the planned path, wherein the handover schedule is based on the waypoints.

Example 118 is a is a non-transitory computer readable medium that includes instructions, which if executed, cause one or more processors to receive wireless connectivity information about waypoints in a path along which a robot expects to move. The instructions also cause the one or more processors to determine, based on the wireless connectivity information, a corresponding wireless configuration for each corresponding waypoint. The instructions also cause one or more processors to generate an instruction for the robot to wirelessly communicate according to the corresponding wireless configuration when the robot moves to the corresponding waypoint.

Example 119 is the non-transitory computer readable medium of example 118, wherein the corresponding wireless configuration includes a target wireless infrastructure device for the robot to use for wireless communications at the corresponding waypoint and a time to perform a handover of the wireless communications to the target wireless infrastructure device.

Example 120 is the non-transitory computer readable medium of example 119, wherein the handover of the wireless communications to the target wireless infrastructure device is from a previous wireless infrastructure device associated with a previous waypoint in the path.

Example 121 is the non-transitory computer readable medium of any one of examples 118 to 120, wherein the wireless connectivity information includes at least one of a wireless channel quality, a wireless link reliability, a data throughput, a wireless resource availability, and a wireless transmission latency along the path.

Example 122 is the non-transitory computer readable medium of any one of examples 118 to 121, wherein the instructions also cause one or more processors to determine the waypoints in the path based on the wireless connectivity information.

Example 123 is the non-transitory computer readable medium of any one of examples 118 to 122, wherein the instructions also cause one or more processors to receive a message from a mobility controller with updated wireless connectivity information about at least one waypoint in the path, wherein the instructions also cause one or more processors to update at least one of the waypoints in the path based on the updated wireless connectivity information.

Example 124 is the non-transitory computer readable medium of any one of examples 118 to 123, wherein the instructions also cause one or more processors to schedule a time for a wireless communication handover from a selected one wireless infrastructure device for wireless communications of the robot along the path from a first waypoint of the waypoints to a selected other wireless infrastructure device for wireless communications of the robot at a subsequent waypoint of the waypoints.

Example 125 is the non-transitory computer readable medium of any one of examples 118 to 124, wherein the instructions also cause one or more processors to transmit a message that requests, based on the planned path, a reservation of wireless resources on a wireless infrastructure device for use by the robot at a waypoint from among the waypoints at a predefined time.

Example 126 is the non-transitory computer readable medium of any one of examples 118 to 125, wherein the instructions also cause one or more processors to transmit robot information for authentication and association of the robot with a wireless infrastructure device for use by the robot at a waypoint from among the waypoints along the planned path.

Example 127 is the non-transitory computer readable medium of any one of examples 118 to 126, wherein the instructions also cause one or more processors to transmit wireless transmission experience information about actual wireless transmissions experienced by the robot along the planned path.

Example 128 is the non-transitory computer readable medium of example 127, wherein the wireless transmission experience information includes at least one of wireless channel quality information, wireless link reliability information, data throughput information, wireless resource availability information, and wireless transmission latency information.

Example 129 is the non-transitory computer readable medium of any one of examples 118 to 128, wherein the instructions also cause one or more processors to transmit the waypoints along the planned path and to receive a handover schedule for wireless infrastructure devices along the planned path, wherein the handover schedule is based on the waypoints.

While the disclosure has been particularly shown and described with reference to specific aspects, it should be understood by those skilled in the art that various changes in form and detail may be made therein without departing from the spirit and scope of the disclosure as defined by the appended claims. The scope of the disclosure is thus indicated by the appended claims and all changes, which come within the meaning and range of equivalency of the claims, are therefore intended to be embraced.

1. An apparatus comprising a processor configured to:
receive an expected location into which a robot plans to move at a predefined time;
determine, based on the expected location and a current location of the robot, an infrastructure configuration for a wireless infrastructure device that provide wireless connectivity at the expected location; and
generate a message to configure the wireless infrastructure device at the predefined time according to the infrastructure configuration.

2. The apparatus of claim 1, wherein the infrastructure configuration comprises a reservation of wireless resources on the wireless infrastructure device for use by the robot at the predefined time.

3. The apparatus claim 1, wherein the infrastructure configuration comprises an antenna directivity, an output power, or a maximum user capacity of the wireless infrastructure device.

4. The apparatus of claim 1, wherein the processor is further configured to forward to the wireless infrastructure device data intended for the robot from a current wireless infrastructure device with which the robot is configured to wirelessly communicate at the current location.

5. The apparatus of claim 1, wherein the wireless infrastructure device comprises a wireless access point that operate according to a wireless communication standard.

6. The apparatus of claim 1, wherein the message includes robot information for authentication and association of the robot with the wireless infrastructure device.

7. The apparatus of claim 1, wherein the expected location is associated with a probability of a handover event from another wireless infrastructure device as the robot moves to the expected location, wherein the processor is further configured to determine the infrastructure configuration based on the probability.

8. The apparatus of claim 1, wherein the expected location is one of a series of waypoints along an expected path of the robot, wherein the processor is further configured to determine, based on the series of waypoints along the expected path, a target wireless infrastructure device from among a plurality of wireless infrastructure devices, wherein the target wireless infrastructure device is to be used by the robot for each waypoint and as the robot moves along the expected path.

9. The apparatus of claim 1, wherein the processor is further configured to:
receive a plurality of expected paths from a plurality of robots; and
determine, further based on the plurality of expected paths, the infrastructure configuration for the wireless infrastructure device and other wireless infrastructure devices, wherein the infrastructure configuration comprises a handover schedule for each robot of the plurality of robots, wherein the corresponding handover schedule indicates a time at which the each robot is to handoff wireless communications between the wireless infrastructure devices and one of the other wireless infrastructure devices.

10. The apparatus of claim 1, wherein the expected location is associated with a plurality of wireless infrastructure devices that serve the expected location, wherein the processor is further configured to select one of the plurality of wireless infrastructure devices as the wireless infrastructure device based on a corresponding transmission parameter for each of the plurality of wireless infrastructure devices at the expected location.

11. The apparatus of claim 10, wherein the corresponding transmission parameter comprises at least one of a wireless channel quality, a wireless link reliability, a data throughput, a wireless resource availability, and a wireless transmission latency.

12. A non-transitory computer readable medium that includes instructions, which if executed, cause one or more processors to:
receive wireless connectivity information about locations in an environment in which a robot may operate;
determine, based on the wireless connectivity information, waypoints in a planned path for the robot from among the locations in the environment; and
generate movement instructions for the robot to move along the planned path through each of the waypoints.

13. The non-transitory computer readable medium of claim 12, wherein the instructions also cause the one or more processors to determine, for each waypoint, a corresponding target wireless infrastructure device to be used by the robot at the waypoint, wherein the corresponding target wireless infrastructure device is based on the wireless connectivity information and selected from among a plurality of wireless infrastructure devices that serve the environment.

14. The non-transitory computer readable medium of claim 12, wherein the wireless connectivity information comprises corresponding transmission parameters at each location of the locations in the environment, wherein the corresponding transmission parameters comprise at least one of a wireless channel quality, a wireless link reliability, a data throughput, a wireless resource availability, and a wireless transmission latency at the location.

15. The non-transitory computer readable medium of claim 12, wherein the processor is further configured to schedule a time for a wireless communication handover from a selected one wireless infrastructure device for wireless communications of the robot at a waypoint of the waypoints to a selected other wireless infrastructure device for wireless communications of the robot at a subsequent waypoint of the waypoints location.

16. The non-transitory computer readable medium of claim 12, wherein the processor is further configured to request, based on the planned path, a reservation of wireless resources on a wireless infrastructure device for use by the robot at a waypoint from among the waypoints at a predefined time.

17. The non-transitory computer readable medium of claim 12, wherein the processor is further configured to transmit the waypoints along the planned path and receive a handover schedule for wireless infrastructure devices along the planned path, wherein the handover schedule is based on the waypoints.

18. A robot comprising:
a wireless transceiver configured to receive wireless connectivity information about waypoints in a path along which robot expects to move; and
a path planning circuit in communication with the wireless transceiver, the path planning circuit configured to:
determine, based on the wireless connectivity information, a corresponding wireless configuration for each corresponding waypoint; and
generate an instruction for the wireless transceiver to wirelessly communicate according to the corresponding wireless configuration when the robot moves to the corresponding waypoint.

19. The robot of claim 18, wherein the path planning circuit is further configured to determine the waypoints in the path based on the wireless connectivity information.

20. The robot of claim 18, wherein the wireless transceiver is further configured to receive a message from a mobility controller with updated wireless connectivity information about at least one waypoint in the path, wherein the path planning circuit is further configured to update at least one of the waypoints in the path based on the updated wireless connectivity information.
